(19) United States
(12) Patent Application Publication
(10) Pub. No.: US 2006/0267789 A1
(43) Pub. Date: Nov. 30, 2006

(54) Multimedia tour system

(76) Inventor: Janice Baldwin, Rhinebeck, NY (US)

Correspondence Address: JOHN MAIER, III, 660 AARON COURT, KINGSTON, NY, 12401, US

(21) Appl. No.: 11/444,065

(22) Filed: May 31, 2006

Related U.S. Application Data
(60) Provisional application No. 60/686,500, filed on May 31, 2005.

(51) Int. Cl. G08B 5/22

(52) U.S. Cl. 340/825.49; 340/996

(57) ABSTRACT

A method for a Multimedia Tour System for use to present predetermined information about each specific location of a viewer on a tour. A delivery device is provided with synchronized video and audio presentations. The delivery device includes a local processor, a plurality of locations are selected to be considered by the viewer. A plurality of tour presentations are provided for each tour location and are retained within the local processor.

### RELATED APPLICATIONS

This application claims priority based upon Provisional Patent Application, Ser. No. 60/686500 filed on May 31, 2005 and entitled Remote Multimedia Tour System

### BACKGROUND OF THE INVENTION

1. Field of the Invention

This invention relates to a system for providing tours of various facilities and, more specifically, relates to a tour system with a visual reality tour guide providing both visual and audio information at various locations along the tour.

2. Prior Art

Most tours rely on a host of tour guides that are knowledgeable on topics to be covered. This requires a great deal of training and, if detailed, technical or current development information is required, a significant level of resources must be applied to assure that consistent delivery and relevant updates are maintained. Some tours offer an audio recording to aid in this area to replace the tour guide completely. Still others offer a kiosk device that augments the exhibits physical display with multimedia content. There are some tour environments where a simple audio or kiosk displays are not sufficient to convey the information specific to the interest of the viewer. Specifically, if it is not practical or possible to train the tour guides with in-depth knowledge or if the tour displays have a great variation limiting the delivery of the full range of material available on the subject matter, it is ideal to supplement the subject matter with a synchronized multimedia session on a remote hand-held device.

### SUMMARY OF THE INVENTION

A method is provided for a Multimedia Tour System for use by a viewer on a tour of at least one location. The viewer is provided with a delivery device that produces synchronized audio and video presentations. A location is designated to be considered by the viewer. At least one presentation is provided to be selected at each location. Each presentation has a synchronized video and audio presentation. The delivery device includes means to activate a selected tour presentation pertaining to the specific location.

### BRIEF DESCRIPTION OF THE DRAWINGS

FIG. 1 is a plan view of the delivery device.

FIG. 2 is a pictorial view of a tablet personal computer such as can be used as the delivery device.

FIG. 3 is a sample screen presentation as may be shown on the delivery device.

### BRIEF DESCRIPTION OF THE NUMERALS

BRIEF DESCRIPTION OF THE NUMERALS

| NUMERAL | DESCRIPTION |
|---|---|
| 11 | Local Device |
| 12 | Centralized Server |
| 13 | Viewer Selection Device |
| 14 | Display Device |
| 15 | Audio Delivery Device |
| 16 | Supporting Devices |
| 17 | Local Processor |
| 18 | Local Content Files |
| 19 | Local Session Log |
| 20 | Central Processor |
| 21 | Central Content Files |
| 22 | Central Session Log |
| 30 | Background |
| 31 | Visual Tour Guide |
| 33 | Options |
| 34 | Reference Text |

### DETAILED DESCRIPTION OF THE PREFERRED EMBODIMENT

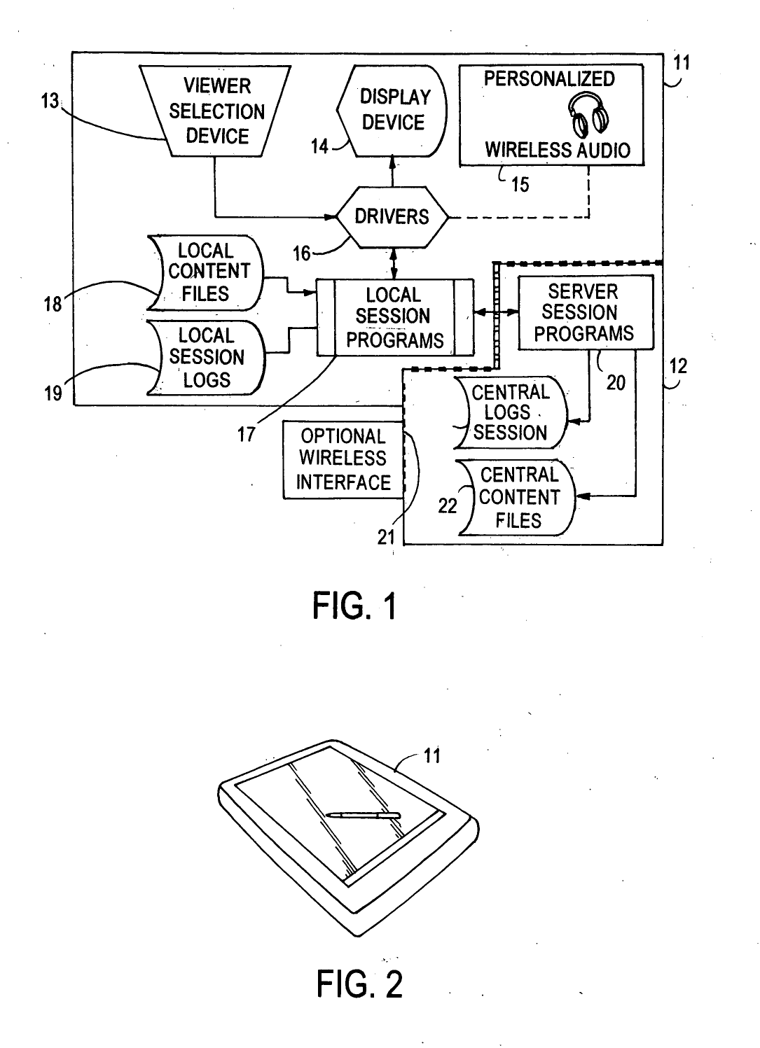

The delivery device (FIG. 1) for the remote Multimedia Tour System can be supported by any device that provides synchronized video, audio and interactive media functions. The embodiment can also be self-contained with a local device 11, although updates are more readily administered through a network from a centralized server 12. The delivery user interface consists of at least a viewer selection device 13, a display service 14 and an audio delivery device 15 and supporting driver 16. In the self-contained embodiment, content for the Multimedia Tour System is controlled by local session programs executed within a local processor 17 using content contained within local content files 18 and maintained session records in a local session log 19. One alternative embodiment is to stream content to the local device 11 by means of remote transmission such as a wireless network or local broadcast in any number of technological forms. The tour device will provide to one or more viewers a synchronized audio through wireless channels and the audio delivery device 15 and personal listening hardware 15. The audio may also have language options to improve the session communications. In the self-contained embodiment the session device 11 would be programmed to download log files and upload update information at specific points in time as required.

In the central-controlled embodiment, content for the Multimedia Tour System is provided through a wireless connection central server 11, session executed within a central processor 20, using content contained within central content files 21. The server 12 maintains session records in a central log 22. A session log 22 is maintained to record the interaction for future reference and analysis. The display, depending upon the size and resolution, can be configured into a suitable visual layout. A common imaging and data format will aid in providing a consistent delivery over various devices with minimal manual format adjustment.

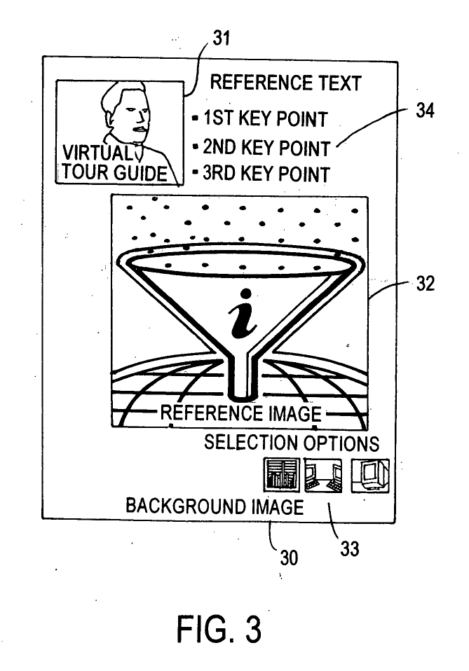

A typical embodiment for the delivery device may be a tablet personal computer, personal digital assistant, personal communication device which could be cell phone. The preferred embodiment would have an easy to use interface such as a touch screen or cursor control. The screen image as shown in FIG. 3 represents one of the many layout configurations that the local Multimedia Tour screen could display. Each screen would consist of a background 30 that serves purely as a visual backdrop or as a functional element of the interactive environment. Upon this background, any number of elements pertaining to the subject matter or viewer options can be displayed and made selectable. The screen displays any number of elements that enhance the tour experience through a multitude of themes to portray subject matter to the viewer. The themes are used as a mechanism to make the viewer's interaction more captivating or relevant to the subject matter.

During the Multimedia Tour, prerecorded messages of an audio/video nature can lead viewers just as would a regular tour guide 23. The topics of specific interest to the viewer that relate to a location along the tour route can be selected by the viewer during the session. To enhance the guidance of the experience of the viewer the delivery device can bring additional reference images 32 such as display events, simulations, diagrams, maps, process flows and examples. During the delivery the viewer may be given control to select options 33 to focus on areas pertaining to the subject matter and request additional information on the current topic and to contour the subject matter to better address the interest of the viewer. Points or other key information can be displayed as reference text 34 to emphasize the elements of subject matter making them available to the viewer as the session proceeds.

Potential data regarding a session is logged and can be reviewed in tabular form. To provide additional knowledge of viewer interests or can be compiled for analysis and trending evaluation in populations. This can also be gathered by administering evaluation as part of the session.

The development of a specific computer tablet program which a particular area of interest highlights carries the tablet on tour and with the aid of a tour guide the viewer can select segments to view at specific locations. Specialized areas of interest can be blended with general areas of interest on the tour.

It is to be understood that the drawings and description matter are in all cases to be interpreted as merely illustrative of the principles of the invention rather than as limiting the same in way, since it is contemplated that various elements to achieve like results without departing from the spirit of the invention or the scope of the appended claims.

1. A method for providing a Multimedia Tour System for use by a viewer comprising:
Providing to the viewer a delivery device that produces synchronized video and audio presentations.
Designating a location to be considered by the viewer providing at least one presentation as to a selected tour, each presentation having a synchronized video and audio presentation, a delivery device including means for the viewer to activate a selected tour presentation pertaining to the location.

2. A method according to claim 1 wherein the delivery device is a tablet personal computer.

3. A method according to claim 1 wherein the device is a personal digital assistant.

4. A method according to claim 1 wherein the delivery device is a personal communication device.

5. A method according to claim 1 wherein the delivery device has a local processor.

6. A method according to claim 1 wherein the delivery device has a cursor control.

7. A method for providing a Multimedia Tour System for use by a viewer:
providing to the viewer a delivery device that provides synchronized video and audio presentations.
the delivery device including a local processor.
the content for the synchronized video and audio presentation being contained within the local processor.
designating plurality of locations to be considered by the viewer providing a plurality of tour presentations for each of the tour presentations, each presentation having a synchronized audio presentation and visual presentation, the content for the synchronized video and audio presentation being contained within the local processor.

8. A method according to claim 7 wherein the content for the synchronized video and audio presentation is supplied by means of remote transmission.

9. A method according to claim 7 wherein the delivery device is a tablet personal computer.

10. A method according to claim 7 wherein the delivery device is a personal digital assistant.

11. A method according to claim 7 wherein the delivery device is a personal communications device.

12. A method according to claim 7 wherein the delivery device has a visual screen.
